(19) United States
(12) Patent Application Publication
(10) Pub. No.: US 2024/0184962 A1
(43) Pub. Date: Jun. 6, 2024

(54) FIRE SPRINKLER SIMULATION SYSTEM

(71) Applicant: Tyco Fire Products LP, Cranston, RI (US)

(72) Inventor: Arash Agan, Pawtucket, RI (US)

(73) Assignee: Tyco Fire Products LP, Cranston, RI (US)

(21) Appl. No.: 18/553,791

(22) PCT Filed: May 16, 2022
(86) PCT No.: PCT/IB2022/054541

§ 371 Date: Oct. 3, 2023

Related U.S. Application Data
(60) Provisional application No. 63/196,461, filed on Jun. 3, 2021.
(60) Provisional application No. 63/231,604, filed on Aug. 10, 2021.

(51) Int. Cl. G06F 30/28; A62C 35/62; A62C 35/68

(52) U.S. Cl. CPC G06F 30/28; A62C 35/62; A62C 35/68

(57) ABSTRACT

Systems and methods herein are directed to determining a dry sprinkler system. The methods can include receiving. via a data processing system, a plurality of inputs based on conditions at a plurality of locations of a dry sprinkler system configuration. The method can include determining, via the data processing system, a discharge time of a fire suppressing fluid to a sprinkler based on the plurality of inputs. The identified dry sprinkler system configuration can include a network of pipes having a dry portion. a wet portion fluidly coupled with a dry portion. or a fluid flow control valve separating the wet portion from the dry portion. The sprinkler can be fluidly coupled with the dry portion of the network of pipes. The sprinkler can receive the fire suppressing fluid from the wet portion of the network of pipes.

### CROSS-REFERENCE TO RELATED APPLICATIONS

The present application claims the benefit of and priority to U.S. Provisional Application No. 63/196,461, filed Jun. 3, 2021 and to U.S. Provisional Application No. 63/231,604, filed Aug. 10, 2021, the disclosures of which are incorporated herein by reference in their entirety.

### BACKGROUND

Buildings and other areas can include sprinklers to provide fire protection. In the event of a fire, the sprinklers can dispense a fluid to control, suppress or extinguish the fire over an area.

### SUMMARY

At least one aspect is directed to a dry sprinkler simulation system. The dry sprinkler simulation system can include a data processing system. The data processing system receive a plurality of inputs and estimate a discharge time of a fire suppressing fluid based on the plurality of inputs. The data processing system can include a fluid pressure determination component. The fluid pressure determination component can receive a pressure value of the fire suppressing fluid. The data processing system can include an air pressure determination component. The air pressure determination component can receive a pressure value of air. The data processing system can include a valve features determination component. The valve features determination component can receive characteristics of a fluid flow control valve. The data processing system can include a trim determination component. The trim determination component can receive a plurality of elements of a releasing trim. The data processing system can include a fluid delivery output component. The fluid delivery output component can estimate the discharge time of the fire suppressing fluid. The data processing system can include a sprinkler system generator component. The sprinkler system generator component can identify a dry sprinkler system configuration that includes a network of pipes, a fluid flow control valve, and at least one sprinkler coupled with a portion of the network of pipes.

At least one aspect is directed to a data processing system. The data processing system can determine a parameter of a dry sprinkler system configuration. The data processing system can include a fluid pressure determination component. The fluid pressure determination component can receive a pressure value of the fire suppressing fluid. The data processing system can include an air pressure determination component. The air pressure determination component can receive a pressure value of air. The data processing system can include a valve features determination component. The valve features determination component can receive characteristics of a fluid flow control valve. The data processing system can include a trim determination component. The trim determination component can receive a plurality of elements of a releasing trim. The data processing system can include a fluid delivery output component. The fluid delivery output component can estimate a discharge time of the fire suppressing fluid to a sprinkler of the dry sprinkler system. The data processing system can include a sprinkler system generator component. The sprinkler system generator component can identify a dry sprinkler system configuration that includes a network of pipes, a fluid flow control valve, and at least one sprinkler coupled with a portion of the network of pipes.

At least one aspect is directed to a method of determining a dry sprinkler system configuration. The method can include receiving, via a data processing system, a plurality of inputs based on conditions at a plurality of locations of the dry sprinkler system configuration. The method can include determining, via the data processing system, a discharge time of a fire suppressing fluid to a sprinkler based on the plurality of inputs. The dry sprinkler system configuration can include a network of pipes having a dry portion, a wet portion fluidly coupled with a dry portion, or a fluid flow control valve separating the wet portion from the dry portion. The sprinkler can be fluidly coupled with the dry portion of the network of pipes. The sprinkler can receive the fire suppressing fluid from the wet portion of the network of pipes.

At least one aspect is directed to a method of determining a parameter of a dry sprinkler system configuration. The method can include receiving, via a data processing system, a plurality of inputs based on conditions at a plurality of locations of the dry sprinkler system configuration. The method can include determining, via the data processing system, the discharge time of a fire suppressing fluid to at least one sprinkler based on the plurality of inputs. The dry sprinkler system configuration can include a network of pipes. The network of pipes can have a dry portion, a wet portion fluidly coupled with the dry portion, or a fluid flow control valve separating the wet portion from the dry portion. The sprinkler can be fluidly coupled with the dry portion of the network of pipes. The sprinkler can receive the fire suppressing fluid from the wet portion of the network of pipes.

At least one aspect is directed to a method of determining a parameter of a dry sprinkler system configuration. The method can include providing a data processing system. The data processing system can include a fluid pressure determination component. The fluid pressure determination component can receive a pressure value of a fire suppressing fluid. The data processing system can include an air pressure determination component. The air pressure determination component can receive a pressure value of air. The data processing system can include a valve features determination component. The valve features determination component can receive characteristics of a fluid flow control valve. The data processing system can include a trim determination component. The trim determination component can receive a plurality of elements of releasing trim. The data processing system can include a fluid delivery output component. The fluid delivery output component can estimate a discharge time of the fire suppressing fluid to a sprinkler of the dry sprinkler system. The data processing system can include a sprinkler system generator component. The sprinkler system generator component can identify a dry sprinkler system configuration that includes a network of pipes, a fluid flow control valve, and at least one sprinkler coupled with a portion of the network of pipes.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of a portion of a dry sprinkler simulation system showing a dry sprinkler system configuration, according to an example implementation.

FIG. 2 is a schematic of a portion of a data processing system, according to an example implementation.

FIG. 3 is a front view of a portion of a fluid flow control valve of the dry sprinkler system configuration of FIG. 1 in a closed position, according to an example implementation.

FIG. 4 is a front view of a portion of a fluid flow control valve of the dry sprinkler system configuration of FIG. 1 in an opened position, according to an example implementation.

FIG. 5 is a perspective view of a portion of a releasing trim system of the dry sprinkler system configuration of FIG. 1, according to an example implementation.

FIG. 6 is an illustration of a portion of the data processing system of FIG. 2, according to an example implementation.

FIG. 7 is an illustration of a portion of the data processing system of FIG. 2, according to an example implementation.

FIG. 8 is an illustration of a process of determining a parameter of a dry sprinkler system configuration, according to an example implementation.

FIG. 9 is an illustration of a process of determining a parameter of a dry sprinkler system configuration, according to an example implementation.

FIG. 10 is an illustration of a process of simulating a dry sprinkler system configuration, according to an example implementation.

### DETAILED DESCRIPTION

Following below are more detailed descriptions of various concepts related to, and implementations of, methods, apparatuses, and systems of modeling, analyzing, and designing a fire sprinkler system configuration and determining a discharge time of a fire suppressing fluid of the fire sprinkler system configuration. The various concepts introduced above and discussed in greater detail below may be implemented in any of numerous ways.

Incorporated herein in its entirety by reference thereto is U.S. Pat. No. 8,065,110 filed Sep. 17, 2004 and titled “SYSTEM AND METHOD FOR EVALUATION OF FLUID FLOW IN A PIPING SYSTEM.” Further incorporated herein in its entirety by reference thereto is U.S. Pat. No. 8,612,189 filed Oct. 3, 2006 and titled “SYSTEM AND METHOD FOR EVALUATION OF FLUID FLOW IN A PIPING SYSTEM.” Further incorporated herein in its entirety by reference thereto is U.S. Pat. No. 8,725,457 filed Oct. 2, 2009 and titled “SYSTEM AND METHOD FOR EVALUATION OF FLUID FLOW IN A PIPING SYSTEM.”

The present disclosure generally refers to systems and methods for modeling and designing a fire sprinkler system configuration. In particular, the present disclosure refers to systems and methods for modeling, analyzing, and designing a dry fire sprinkler system configuration that is configured to disperse water from one or more sprinklers over a desired area. For example, the dry fire sprinkler system configuration can be used to model (e.g., graphically represent) various dry fire sprinkler systems such as those used in warehouses, outdoors, or any other environment in which temperature may not be controlled.

At least one aspect of the present disclosure is a data processing system for determining a parameter, such as a discharge time of a fire suppressing fluid, of a fire protection sprinkler system configuration. For example, the data processing system can include various processors to receive a plurality of inputs and model a fire protection sprinkler system based on the plurality of inputs. For example, the fire protection system configuration (e.g., a model of a “real world” fire protection sprinkler) may include one or more sprinklers which are configured to inhibit or permit flow of fluid (typically water, but also in some applications fire suppressant fluid) depending upon conditions. In the instance of a fire or detected conditions that may be indicative of a fire (e.g., increased heat, smoke, etc.), the sprinklers are configured to permit the flow of fluid such that the fluid may contact a deflector and be dispersed so as to provide protection to an outdoor area.

The fire protection sprinkler system configuration can model a corresponding “real world” fire protection sprinkler system. For example, the fire protection sprinkler system configuration can include a variety of computer aided graphic models (e.g., CAD), simulations, graphical nodes, or other similar methods of simulation to closely model a fire protection sprinkler system (e.g., a tangible system). Similar to an actual fire protection sprinkler system, the fire protection sprinkler system configuration can include a network of pipes for providing the fire suppressing fluid to one or more sprinklers for providing fire protection. The fire protection sprinkler system configuration can include a fluid flow control valve for controlling a flow rate of the fire suppressing fluid. The fluid flow control valve can operate between a closed position, in which the fire suppressing fluid is inhibited from flowing through the valve, and an open position, in which the fire suppressing fluid can flow through the valve. In some example implementations, the fluid flow control valve may not switch from a closed position to an open position instantaneously. For example, it may take an amount of time for a valve seal to move into a fully opened position to allow the fire suppressing fluid to flow through the valve without any inhibition. Many fire safety standards require the fire suppressing fluid to discharge out of the sprinklers of the fire protection sprinkler system within a specific amount of time from when the fire protection sprinkler system is activated (e.g., 20 seconds, 30 seconds, 40 seconds). Accordingly the data processing system can receive several inputs to facilitate simulating the fire protection sprinkler system configuration and determining, based on said inputs, the time it may take for the fire suppressing fluid to discharge from the sprinkler (e.g., in a real world application where the dry sprinkler system is installed in a building or facility).

Referring generally to the figures, a data processing system can be configured to determine (e.g., model, identify, simulate, visualize, determine information regarding) a fire protection system including sprinklers which are configured to inhibit or permit flow of fluid (typically water, but also in some applications fire suppressant fluid) depending upon conditions. In the instance of a fire or detected conditions that may be indicative of a fire (e.g., increased heat, smoke, etc.), the sprinklers are configured to permit the flow of fluid such that the fluid may contact a deflector and be dispersed so as to provide protection to an outdoor area.

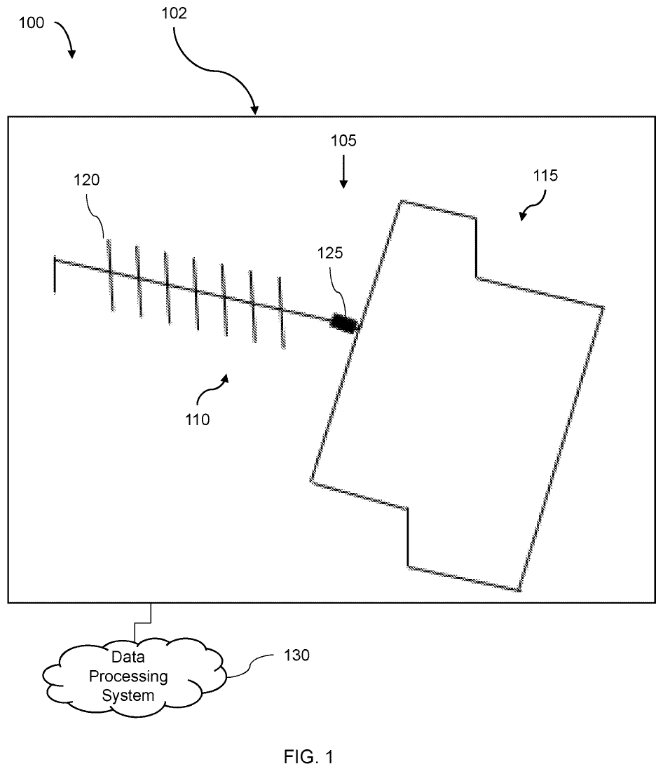

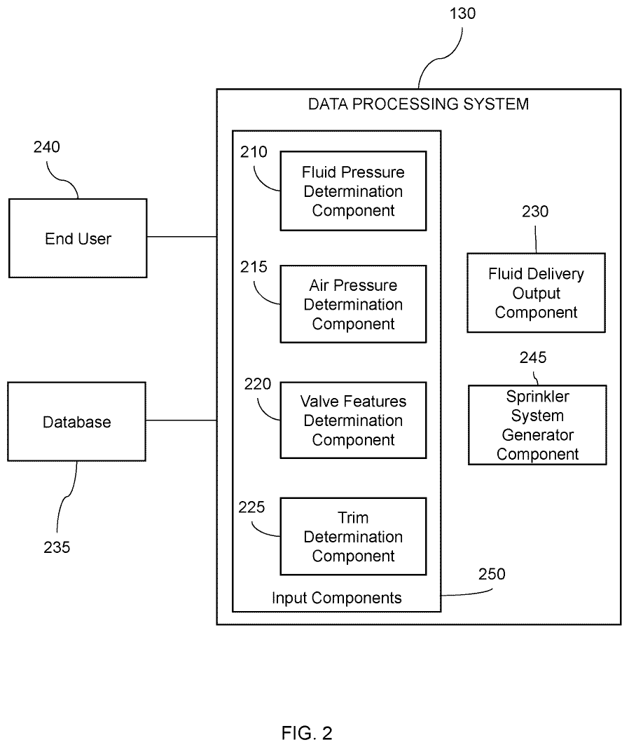

FIG. 1 depicts a dry sprinkler simulation system 100. For example, the dry sprinkler simulation system 100 can include a dry sprinkler system configuration 102. For example, the dry sprinkler system configuration 102 can include a variety of computer aided graphic models (e.g., CAD), simulations, graphical nodes, or other methods of simulation to closely determine (e.g., model, identify, simulate, visualize, determine information regarding) a fire protection sprinkler system (e.g., an actual, tangible system). The dry sprinkler simulation system 100 can include one or more data processing systems 130, as shown in greater detail in FIG. 2. For example, the data processing system 130 can operate with a database 235, such as, for example, a computer disc, hard disc, centralized server, mobile device, or any other computer memory storage device, for processing data. The data processing system 130 can operate with an end user 240, as another example. For example, the data processing system 130 can be accessed by a computer processing device locally, such as off of local hard disk space, or alternatively the data processing system 130 can be accessed or stored remotely from a central server or other storage device over a network such as, for example, a LAN, WAN or Internet. The data processing system 130 can be interfaced or communicated with the devices of a computer, mobile device, or other device, so as to provide a user interface for the end user 240 to model, simulate, or analyze the dry sprinkler system configuration 102, for example. As shown in more detail in FIG. 2, and as discussed in greater detail below, the data processing system 130 can include several input components 250, such as a fluid pressure determination component 210, an air pressure determination component 215, a valve features determination component 220, and a trim determination component 225. The data processing system can include one or more output components, such as a fluid delivery output component 230 and a sprinkler system generator component 245. The data processing system 130 can include various amounts of input components 250 or output components. For example, the data processing system 130 can include four or more input components 250.

The data processing system 130 can include less than four input components 250. The data processing system 130 can include one or more output components (e.g., the fluid delivery output component 230). In various examples, the data processing system 130 may not include an output component.

The dry sprinkler system configuration 102 can model (e.g., represent) a dry sprinkler system to provide fire protection for an area. For example, the dry sprinkler system configuration 102 can include a network of pipes 105. For example, the network of pipes 105 can include a dry portion 110 and a wet portion 115. The dry portion 110 can include at least one portion that is free from liquid when the dry sprinkler system configuration 102 is not activated. The wet portion 115 can include a fire suppressing fluid. For example, the fire suppressing fluid can be water, a fire suppressing agent, another fluid, or any combination thereof. The dry portion 110 can be fluidly coupled with the wet portion 115. The network of pipes 105 can include at least one component, such as a valve, for separating the wet portion 115 from the dry portion 110. For example, the wet portion 115 can be separated from the dry portion 110 by means of a fluid flow control valve 125. The fluid flow control valve 125 can control a fluid flow rate of the fire suppressing fluid between the wet portion 115 and the dry portion 110 in a vast number of ways. For example, the fluid flow control valve 125 can inhibit the flow of the fire suppressing fluid from the wet portion 115 to the dry portion 110. The fluid flow control valve 125 can reduce the flow of the fire suppressing fluid from the wet portion 115 to the dry portion 110, as another example. The fluid flow control valve 125 can open completely to allow the fire suppressing fluid to flow from the wet portion 115 to the dry portion 110, as yet another example. While the fluid flow control valve 125 shown primarily in the figures is a diaphragm valve, various examples may include the use of another valve such as stop valves, overboard valves, globe valves, ball valves, pinch valves, or other flow controlling devices.

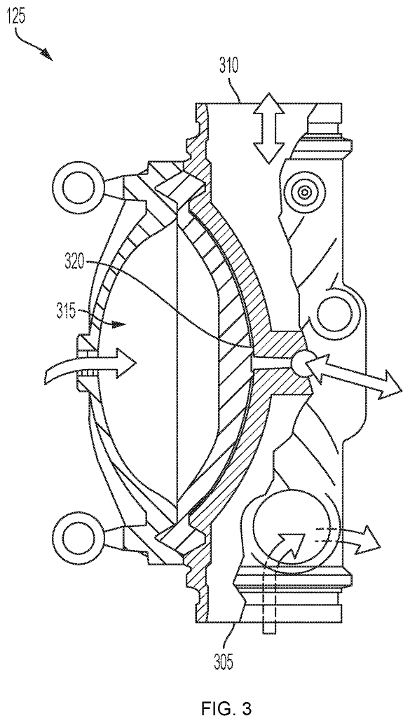

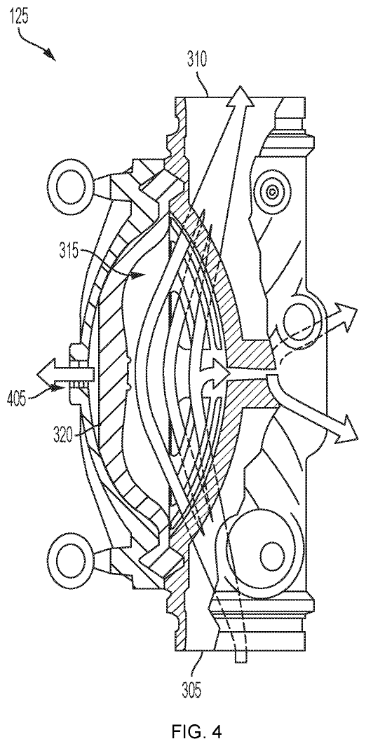

As depicted in FIGS. 3 and 4, among others, the fluid flow control valve 125 can include an inlet 305 and an outlet 310. For example, the fluid flow control valve 125 can receive the fire suppressing fluid from the wet portion 115 of the network of pipes 105 at the inlet 305. The fluid flow control valve 125 can discharge the fire suppressing fluid through the outlet 310 and to the dry portion 110 of the network of pipes 105.

The fluid flow control valve 125 can include a valve chamber 315. For example, the valve chamber 315 can be a channel, cavity, or a similar space in which the fire suppressing fluid may flow when the fluid flow control valve 125 is in an open position. The valve chamber 315 can be devoid of the fire suppressing fluid when the fluid flow control valve 125 is in a closed position. The valve chamber 315 can include a volume of a transmitting fluid 545 when the fluid flow control valve 125 is in a closed position, as described in greater detail below. The fluid flow control valve 125 can include a port 405. For example, the port 405 can include an aperture for expelling the transmitting fluid 545 when the fluid flow control valve 125 moves from a closed position to an open position, as described in greater detail below.

The fluid flow control valve 125 can include a seal 320. For example, the seal 320 can be a thin, flexible material that is positioned within the valve chamber 315 of the fluid flow control valve 125 such that the seal 320 inhibits a flow of the fire suppressing fluid when the fluid flow control valve 125 is in a closed position, as depicted in FIG. 3, or allow a flow of fluid of the fire suppressing fluid through the fluid flow control valve 125 when the valve 125 is in an open position, as depicted in FIG. 4.

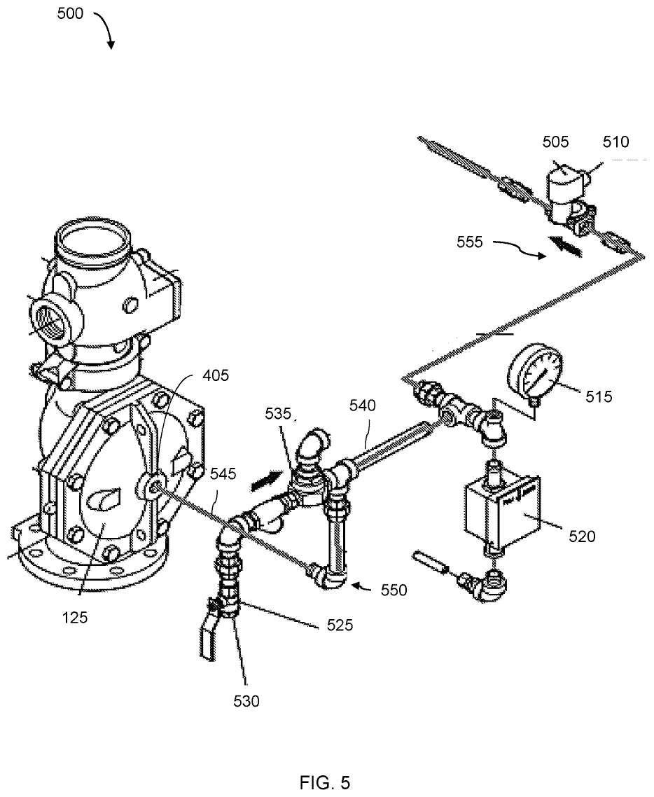

The dry sprinkler system configuration 102 can include a plurality of releasing trim components. An example of a portion of a releasing trim system 500 is depicted in FIG. 5. The releasing trim system 500 can include one or more components that assist in opening or closing the fluid flow control valve 125. For example, the releasing trim system 500 may include one or more components for releasing the seal 320 of the fluid flow control valve 125. For example, when the fluid flow control valve 125 is in a closed position, the valve chamber 315 can include a volume of the transmitting fluid 545 on a side of the seal 320 that opposes the fire suppressing fluid. For example, the volume of the transmitting fluid 545 can apply pressure to the seal 320 such that the seal 320 remains in a closed position and the fire suppressing fluid cannot flow within the valve chamber 315. When the fluid flow control valve 125 is to be opened, the volume of the transmitting fluid 545 within the valve chamber 315 can be expelled through the port 405. As the transmitting fluid 545 is expelled from the valve chamber 315 and through the releasing trim system 500, the pressure loss within the valve chamber 315 can cause the seal 320 to move out of a closed position and into an open position such that the fire suppressing fluid, can flow from the inlet 305 to the outlet 310, as depicted in FIG. 4.

The releasing trim system 500 can include various components for operating the fluid flow control valve 125 including, but not limited to, a water supply pressure gauge, a diaphragm chamber pressure gauge, a diaphragm chamber connection 530, a manual control station 520, a diaphragm chamber supply valve 525, a main drain valve, a system drain valve, an alarm test valve, an automatic drain valve, an automatic shut-off valve 535, a solenoid valve 505, a system air pressure gauge, an air supply connection 510, a lower air pressure alarm switch, and a water flow pressure alarm switch.

The dry sprinkler system configuration 102 can include at least one sprinkler 120. For example, the dry sprinkler system configuration 102 can include one sprinkler 120. The dry sprinkler system configuration 102 can include two sprinklers 120, as another example. The dry sprinkler system configuration 102 can include more than two sprinklers 120, as yet another example. The sprinkler 120 can be fluidly coupled to at least one portion of the dry portion 110 of the network of pipes 105. For example, the sprinkler 120 can be coupled to an outlet of a pipe within the dry portion 110 of the network of pipes 105. The sprinkler 120 can receive the fire suppressing fluid. For example, in the case of a fire, the fluid flow control valve 125 can allow a flow of the fire suppressing fluid to flow from the wet portion 115 of the network of pipes 105 to the dry portion 110 and through the sprinkler 120 to provide fire protection for an area.

The data processing system 130 can receive a plurality of inputs of the dry sprinkler system configuration 102. For example, the data processing system 130 can receive a plurality of inputs from the end user 240 (e.g., end user 240 enters data via a computing device). The data processing system 130 can receive the plurality of inputs from the database 235, as another example. For instance, the data processing system 130 can be configured to obtain data from the database 235. The data processing system 130 can receive the plurality of inputs from a combination of the end user 240 (or a plurality of end users 240) and the database 235, as yet another example. The data processing system 130 can receive a pressure value of fluid within the dry sprinkler system configuration 102. The data processing system 130 can receive a pressure value of air within the dry sprinkler system configuration 102, as another example. The data processing system 130 can receive a plurality of characteristics of the fluid flow control valve 125, as another example. The data processing system 130 can receive a plurality of characteristics of the releasing trim system 500, as yet another example.

The data processing system 130 can receive a pressure value of various fluids at a plurality of locations of the dry sprinkler system configuration 102. For example, the data processing system 130 can receive a pressure value of the fire suppressing fluid at a location of the wet portion 115 of the network or pipes 105. The data processing system 130 can receive a pressure value of the fire suppressing fluid at a location within the dry portion 110 of the network of pipes 105, as another example. The data processing system 130 can receive a pressure value of the fire suppressing fluid at a location within the fluid flow control valve 125, as yet another example. The data processing system 130 can receive a pressure value of the transmitting fluid 545 within the valve chamber 315 or the releasing trim system 500, as another example. For example, the plurality of inputs, such as the pressure value of the fire suppressing fluid, can be simulated from, obtained from, received from, or based on valve readings, sensors, databases, gauge readings, user inputs, or other methods. The fluid pressure determination component 210 can receive this data within the data processing system 130. By way of example, an initial pressure value of the fire suppressing fluid can be obtained by a user of a user interface of the data processing system 130. The data processing system 130 can then determine and output a pressure value of the fire suppressing fluid changing over time based on a flow rate of the fire suppressing fluid and a pressure curve of the transmitting fluid 545 within the releasing trim system 500, as discussed in greater detail below.

The data processing system 130 can receive a pressure value of air at a plurality of locations of the dry sprinkler system configuration 102. For example, the data processing system 130 can receive a pressure value of air within the dry sprinkler system configuration 102 at a location of the wet portion 115 of the network or pipes 105. The data processing system 130 can receive a pressure value of air at a location within the dry portion 110 of the network of pipes 105, as another example. The data processing system 130 can receive a pressure value of air at a location within the fluid flow control valve 125, as yet another example. In various examples, the pressure value of air can be simulated from, obtained from, received from, or based on valve readings, sensors, databases, gauge readings, user inputs, or other methods. The air pressure determination component 215 can receive this data within the data processing system 130. By way of example, an initial air pressure value can be obtained by a user of a user interface of the data processing system 130. The data processing system 130 can then determine and output a pressure value of air changing over time based on other components of the dry sprinkler system configuration 102.

The data processing system 130 can receive a plurality of characteristics of the fluid flow control valve 125. For example, the data processing system 130 can receive a measurement of the fluid flow control valve 125, such as a radius of the inlet 305, a radius of the outlet 310, or a volume of the valve chamber 315 of the fluid flow control valve 125. The data processing system 130 can receive a stiffness value of the fluid flow control valve 125, as another example. The data processing system 130 can receive a volume of water at a location within, behind, or otherwise near the fluid flow control valve 125, as yet another example. The data processing system 130 can receive the characteristics of the fluid flow control valve 125 from an end user 240 or from the database 235. The inputs can also be simulated from, obtained from, received from, or based on valve readings, sensors, databases, gauge readings, user inputs, or other methods, according to various examples. The valve features determination component 220 can receive this data within the data processing system 130. With the received inputs, the data processing system 130 can approximate the fluid flow control valve 125 as a pipe with varying diameter. For example, the data processing system 130 can approximate the fluid flow control valve 125 as a pipe with a diameter of 0 inches when the fluid flow control valve 125 is in a closed position. The data processing system 130 can approximate the fluid flow control valve 125 as a pipe with a diameter greater than 0 inches when the fluid flow control valve 125 is in an open position.

The data processing system 130 can receive a plurality of inputs of the releasing trim system 500. For example, the data processing system 130 can receive a physical value of the releasing trim system 500, such as a length, radius, or volume of a pipe 540 of the releasing trim system 500. The data processing system 130 can receive a volume of the transmitting fluid 545 within the releasing trim system 500, as another example. The data processing system 130 can receive a pressure value of the releasing trim system 500 such as from a pressure gauge 515, as another example. The data processing system 130 can receive an elevation change of the releasing trim system 500, such as a vertical displacement from one point 550 of the releasing trim system 500 to another point 555 of the releasing trim system 500, as yet another example. For example, the releasing trim system 500 inputs can be simulated from, obtained from, received from, or based on valve readings, sensors, databases, gauge readings, user inputs, or other methods, according to various examples. The trim determination component 225 can receive this data within the data processing system 130. By way of example, the plurality of inputs of the releasing trim can be obtained from a user input of a user interface of the data processing system 130.

The data processing system 130 can estimate (e.g., approximate) a discharge time of the fire suppressing fluid. For example, the data processing system 130 can estimate a specific amount of time from when the fire protection sprinkler system is activated (e.g., 20 seconds, 30 seconds, 40 seconds). For example, the data processing system 130 can include a fluid delivery output component 230. The fluid delivery output component 230 can output a discharge time of the fire suppressing fluid. For example, the data processing system 130 can determine, based on the inputs obtained from the fluid pressure determination component 210, the air pressure determination component 215, the valve features determination component 220, and the trim determination component 225, a discharge time of the fire suppressing fluid from the wet portion 115 of the network of pipes 105 to the sprinkler 120, and output the discharge time through the fluid delivery output component 230. For example, the discharge time can be measured as an amount of time it takes for the fire suppressing fluid to reach an outlet point of the sprinkler 120 when the dry sprinkler system configuration 102 is activated (e.g., simulated similarly as in the case of a fire). The data processing system 130 can determine a flow front of the fire suppressing fluid at each sprinkler 120 as the fire suppressing fluid advances throughout the dry sprinkler system configuration 102. For example, the data processing system 130 can determine a flow front at each pipe of the network of pipes leading to the sprinklers 120 at various times (e.g., every 0.01 second, every 0.1 second, every 1 second, every 10 seconds). The data processing system 130 can continue to obtain these inputs until each sprinkler 120 of the dry sprinkler system configuration 102 has discharged the fire suppressing fluid, at which point the discharge time is determined.

The data processing system 130 can include a sprinkler system generator component 245. For example, the sprinkler system generator component can include one or more processors configured to provide the dry sprinkler simulation system 100 with the dry sprinkler system configuration 102. The sprinkler system generator component 245 can, for example, identify the dry sprinkler system configuration 102 based on the plurality of inputs received by the data processing system 130. The end user 240 can facilitate designing (e.g., updating, integrating, improving) the dry sprinkler simulation system 100 by changing the plurality of inputs of the system 100. For example, the end user 240 may increase or decrease the pressure value of the fire suppressing fluid. The end user 240 may increase or decrease the pressure value of the air. The end user 240 may increase or decrease any one of the characteristics of the fluid flow control valve 125, as another example. As the end user 240 changes the plurality of inputs, the sprinkler system generator component 245 may update the dry sprinkler system configuration 102.

A generalized background on the numeration for the dry sprinkler system configuration (e.g., the model) is discussed herein. The fluid flow control valve 125 can be modeled using a pipe that is uniform along the length. The pressure loss of the fluid flow control valve 125 based on the flow of the fire suppressing fluid can be determined using the following formula:

$$Δ p = ρ \frac{L + {L}_{eff}}{D} f ( v ) \frac{{v}^{2}}{2} \qquad ( 6.1 )$$

Where L is pipe length, p is pressure, ρ is density of the fluid, D is diameter of the pipe, v is velocity of the fluid, L_{eff} is the effective length of the pipe calculated using the least squares method, and f is defined in relations:

$$f = \frac{64}{Re} , Re = \frac{ρ vD}{μ} , \qquad ( 1.4 )$$

$$f = {( - 2.0 log \{ \frac{ε}{3.7065 D} - \frac{5.0452}{Re} log [ \frac{1}{2.8257} {( \frac{ε}{D} )}^{1.1098} + \frac{5.8506}{{Re}^{0.8981}} ] \} )}^{- 2} \qquad ( 1.5 )$$

Where Re is Reynolds number and μ is dynamic viscosity of the fluid. One way the fluid pressure within the valve chamber 315 can be calculated is through the following:

$$ρ {L}_{c} \cdot {W}_{c} + {p}_{c} + ρ {gh}_{c} + ρ \frac{{v}_{c}^{2}}{2} + {R}_{cp} = {p}_{p} + ρ {gh}_{p} + ρ \frac{{v}_{p}^{2}}{2} \qquad ( 7.1 )$$

Where the index p denotes a parent node (e.g., one point of piping within the dry sprinkler system configuration 102), the index c denotes the child's node (e.g., another point of piping within the dry sprinkler system configuration 102), and R_{cp} is the fluid resistance in the segment from node p to node c. The resistance, depending on its type, is determined by the formulas

$${R}_{cp} = ρ ( 1 + \frac{L + {L}_{eff}}{D} f ) \frac{{v}_{c}^{2}}{2} or {R}_{cp} = Δ p ,$$

where Δp is the experimentally measured pressure losses in the pipe.

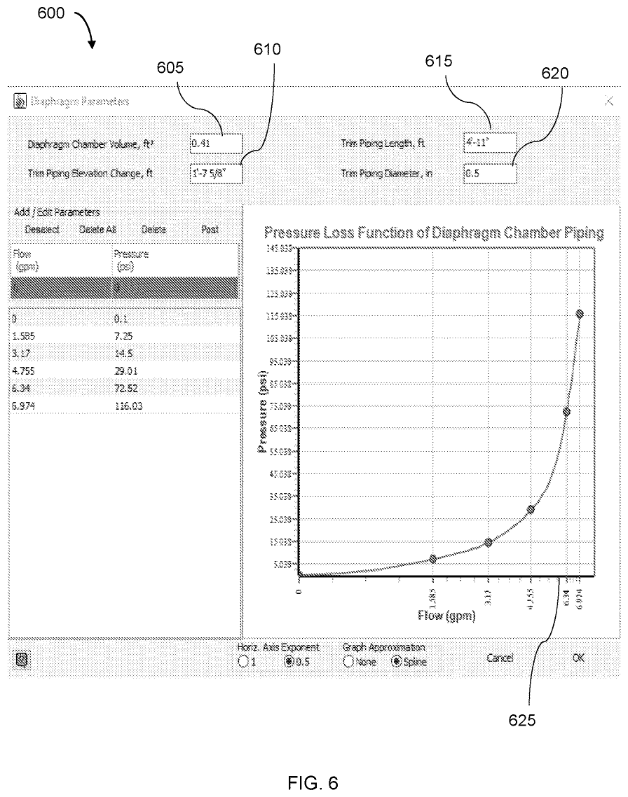

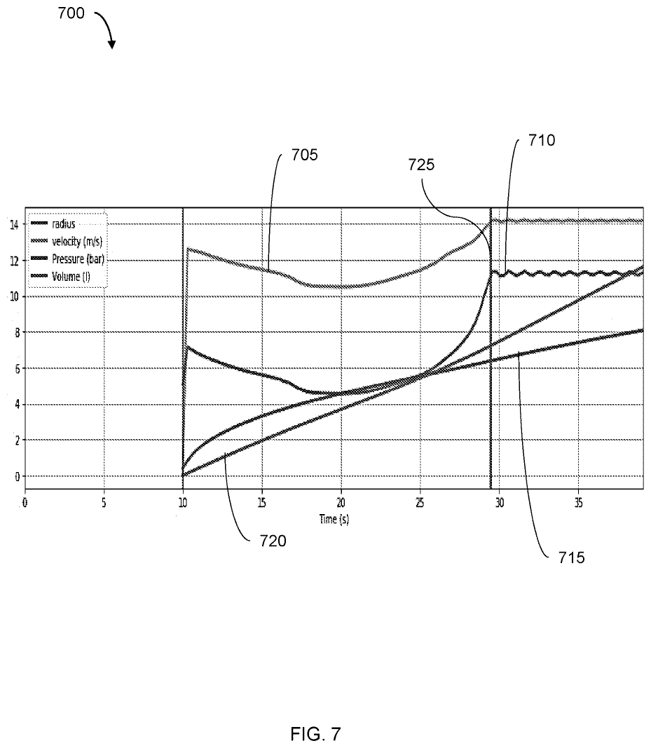

FIGS. 6 and 7 depict examples of the data processing system 130 depicted on a user interface, such as a computer, mobile device, or other methods. FIG. 6 depicts an input window 600, according to an example implementation. For example, a user (e.g., the end user 240) may be able to input a diaphragm chamber volume, as depicted in a chamber volume input box 605. The user may be able to input a trim piping elevation change, as depicted in an elevation change input box 610. The user may be able to input a trim piping length, as depicted in a piping length input box 615. The user may be able to input a trim piping diameter, as depicted in a piping diameter input box 620. The data processing system 130 can then obtain said inputs, such as through the fluid pressure determination component 210, the air pressure determination component 215, the valve features determination component 220, and the trim determination component 225, and determine a pressure value of the fire suppressing fluid within the fluid flow control valve 125 in relation to a flow rate of the fire suppressing fluid over time. The data processing system 130 can output said pressure value within the fluid flow control valve 125 over time to the user, as depicted in a pressure loss graphic 625. The data processing system 130 can use the pressure value over time to determine the discharge time of the fire suppressing fluid to the sprinkler 120. For example, as the fluid flow control valve 125 changes between a closed position and an open position, a pressure value within the fluid flow control valve 125 changes with time. As the fluid flow control valve 125 opens, the volume of the fire suppressing fluid within the dry portion 110 of the network of pipes 105 increases. The data processing system 130 can determine this change over time by approximating the fluid flow control valve 125 as a pipe with varying diameter.

FIG. 7 depicts another example of a graphical output 700 from the data processing system 130. For example, the data processing system 130 can determine, based on a radius value of the fluid control valve (e.g., hydraulic diameter over time) as depicted as line 715, a velocity value of the transmitting fluid 545 (e.g., flow rate relative to area within a pipe), as depicted as line 705. The data processing system 130 can determine a pressure value of the valve chamber 315, as depicted as line 710. The data processing system 130 can determine a volume value of the transmitting fluid 545 expelling from the valve chamber 315 through the releasing trim system 500, as depicted as line 720. The graphical output 700 represents a pressure value of the valve chamber 315 varying with time and flow rate of the fire suppressing fluid. By way of example, the data processing system 130 depicted in FIG. 7 begins obtaining inputs of the dry sprinkler system configuration 102 at a time in which the dry sprinkler system configuration 102 is activated (e.g., 0 seconds, 5 seconds, 10 seconds, etc.). At the time of activation, the fluid flow control valve 125 begins to move into an open position. At this point, the transmitting fluid 545 begins to expel from the valve chamber 315 through the port 405. The transmitting fluid 545 can continue expelling from the valve chamber 315 until the expelled volume of the transmitting fluid 545 is about equal to the volume of the valve chamber 315. As depicted in FIG. 7, the radius, as depicted by line 715, of the approximated pipe of the fluid flow control valve 125 can have a nonlinear relationship to the volume, as depicted by line 720, of the expelled transmitting fluid 545. Line 725 depicts the time at which discharge time of the fire suppressing fluid is measured.

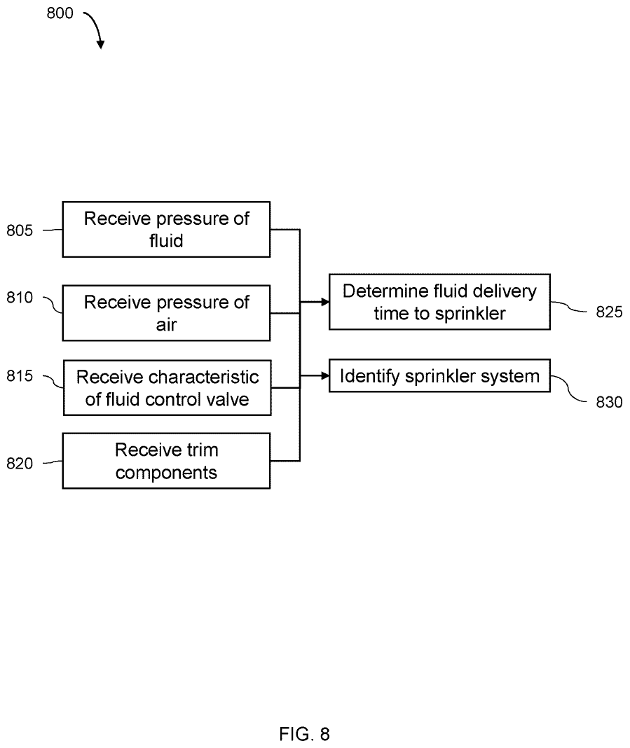

FIG. 8 depicts a method 800 of determining a parameter of a dry sprinkler system configuration 102, such as a discharge time of a fire suppressing fluid. The method 800 can include receiving a pressure value of a fluid within the dry sprinkler system configuration 102, such as the fire suppressing fluid or a transmitting fluid 545, as depicted in act 805. For example, a data processing system 130 can receive a pressure value of the fire suppressing fluid through a user input (e.g., from an end user 240 of a user interface). The data processing system 130 can receive a pressure value of the fire suppressing fluid through a database 235 (e.g., a computer disc, hard disc, centralized server, mobile device, or any other computer memory storage device, for processing data). The data processing system 130 can receive a pressure value of the fire suppressing fluid through a combination of one or more databases 235 or end users 240, as yet another example. The data processing system 130 can receive a pressure value of the fire suppressing fluid via valve readings, gauge readings, sensors, other user inputs, or other methods, as another example. A fluid pressure determination component 210 can receive this data. The fluid pressure determination component 210 can receive a pressure value of the fire suppressing fluid at various locations within the dry sprinkler system configuration 102. For example, the fluid pressure determination component 210 can receive a pressure value of the fire suppressing fluid at a location of a wet portion 115 of a network or pipes 105 within the dry sprinkler system configuration 102. The fluid pressure determination component 210 can receive a pressure value of the fire suppressing fluid at a location within a dry portion 110 of the network of pipes 105, as another example. The fluid pressure determination component 210 can receive a pressure value of the fire suppressing fluid at a location within a fluid flow control valve 125 of the dry sprinkler system configuration 102, as another example. The fluid pressure determination component 210 can receive a pressure value of the transmitting fluid 545, as yet another example.

The method 800 can include receiving a pressure value of air within the dry sprinkler system configuration 102, as depicted in act 810. For example, the data processing system 130 can receive a pressure value of the air within the dry sprinkler system configuration 102 through a user input (e.g., from an end user 240 of a user interface). The data processing system 130 can receive a pressure value of the air through a database 235, as another example. The data processing system 130 can receive a pressure value of the air through a combination of one or more databases 235 or end users 240, as yet another example. The data processing system 130 can receive a pressure value of the air via valve readings, gauge readings, sensors, other user inputs, or other methods, as another example. An air pressure determination component 215 can receive this data. The air pressure determination component 215 can receive a pressure value of the air within the dry sprinkler system configuration 102 at various locations throughout the dry sprinkler system configuration 102. For example, the air pressure determination component 215 can receive a pressure value of air within the dry sprinkler system configuration 102 at a location of the wet portion 115 of the network or pipes 105. The air pressure determination component 215 can receive a pressure value of air at a location within the dry portion 110 of the network of pipes 105, as another example. The air pressure determination component 215 can receive a pressure value of air at a location within the fluid flow control valve 125, as yet another example.

The method 800 can include receiving one or more characteristics of the fluid flow control valve 125, as depicted in act 815. For example, the data processing system 130 can receive the one or more characteristics of the fluid flow control valve 125 through a user input (e.g., from an end user 240 of a user interface). The data processing system 130 can receive the one or more characteristics of the fluid flow control valve 125 through a database 235, as another example. The data processing system 130 can receive the one or more characteristics of the fluid flow control valve 125 through a combination of one or more databases 235 or end users 240, as yet another example. The data processing system 130 can receive the one or more characteristics of the fluid flow control valve 125 via valve readings, gauge readings, sensors, other user inputs, or other methods, as another example. A valve features determination component 220 can receive this data. The valve features determination component 220 can receive a plurality of inputs of the dry sprinkler system configuration 102. For example, the valve features determination component 220 can receive a measurement of the fluid flow control valve 125, such as a radius of an inlet 305 of the fluid flow control valve 125, a radius of an outlet 310 of the fluid flow control valve 125, or a measurement of a valve chamber 315 of the fluid flow control valve 125. The valve features determination component 220 can receive a stiffness value of the fluid flow control valve 125, as another example. The valve features determination component 220 can receive a volume of water at a location within, behind, or otherwise near the fluid flow control valve 125, as yet another example.

The method 800 can include receiving releasing trim component elements, as depicted in act 820. For example, the data processing system 130 can receive the releasing trim component elements through a user input (e.g., from an end user 240 of a user interface). The data processing system 130 can receive the releasing trim component elements through a database 235, as another example. The data processing system 130 can receive the releasing trim component elements through a combination of one or more databases 235 or end users 240, as yet another example. The data processing system 130 can receive the releasing trim component elements via valve readings, gauge readings, sensors, other user inputs, or other methods, as another example. A trim determination component 225 can receive this data. The trim determination component 225 can receive a plurality of inputs of the dry sprinkler system configuration 102. For example, the trim determination component 225 can receive a physical value of a releasing trim system 500, such as a length, radius, or volume of a pipe 540. The trim determination component 225 can receive a pressure value of the releasing trim system 500, such as from a pressure gauge 515, as another example. The trim determination component 225 can receive a volume of a transmitting fluid 545, as another example. The trim determination component 225 can receive an elevation change of the releasing trim system 500, such as a vertical displacement from one point 550 of the releasing trim system 500 to another point 555 of the releasing trim system 500, as yet another example.

The method 800 can include estimating the discharge time of the fire suppressing fluid, as depicted in act 825. For example, the data processing system 130 can include a fluid delivery output component 230. Through the fluid delivery output component 230, the data processing system 130 can analyze the plurality of inputs obtained and determine the discharge time of the fire suppressing fluid based on the plurality of inputs. For example, the data processing system 130 can approximate the fluid flow control valve 125 as a pipe with varying diameter over time. The data processing system 130 can approximate the fluid flow control valve 125 as a pipe with a diameter of 0 inches when the fluid flow control valve 125 is in a closed position, as an example. The data processing system 130 can approximate the fluid flow control valve 125 as a pipe with a diameter increasing over time from 0 inches when the fluid flow control valve 125 moves into an open position, as another example.

The method 800 can include identifying the dry sprinkler system configuration 102, as depicted in act 830. For example, a sprinkler system generator component 245 can identify the dry sprinkler system configuration 102. For example, the sprinkler system generator component can include processors configured to provide the dry sprinkler simulation system 100 with the dry sprinkler system configuration 102. The sprinkler system generator component 245 can, for example, identify the dry sprinkler system configuration 102 based on the plurality of inputs received by the data processing system 130.

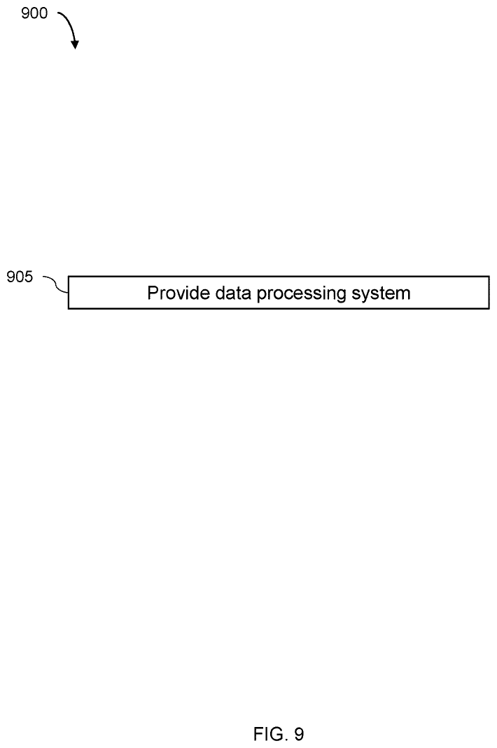

FIG. 9 depicts a method 900 of determining a parameter of a dry sprinkler system configuration 102, such as a discharge time of a fire suppressing fluid. The method 900 can include providing a data processing system 130, as depicted in act 905. For example, the data processing system 130 can include a fluid pressure determination component 210 to receive a pressure value of a fire suppressing fluid within the dry sprinkler system configuration 102. The data processing system 130 can include an air pressure determination component 215 to receive a pressure value of air within the dry sprinkler system configuration 102. The data processing system 130 can include a valve features determination component 220 to receive characteristics of a fluid flow control valve 125. The data processing system 130 can include a trim determination component 225 to receive a plurality of elements of a releasing trim system 500. The data processing system 130 can include a fluid delivery output component 230 to determine the discharge time of the fire suppressing fluid to a sprinkler 120 of the dry sprinkler system configuration 102. The data processing system 130 can include a sprinkler system generator component 245 to identify the dry sprinkler system configuration 102. For example, the

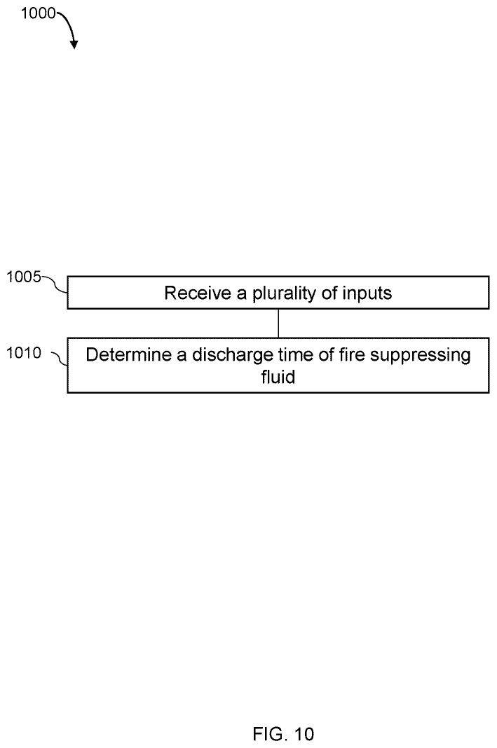

FIG. 10 depicts a method 1000 of analyzing a dry sprinkler system configuration 102. The method 1000 can include obtaining a plurality of inputs of the dry sprinkler system configuration 102. For example, the plurality of inputs can be received via a data processing system 130, as depicted in act 1005. The plurality of inputs can be received to model various locations of the dry sprinkler system configuration 102. The method can include estimating a discharge time of a fire suppressing fluid to a sprinkler 120 of the dry sprinkler system configuration 102, as depicted in act 1010. For example, the dry sprinkler system configuration 102 can include a network of pipes 105. The network of pipes 105 can include a dry portion 110 and a wet portion 115. The wet portion 115 can include the fire suppressing fluid. A fluid flow control valve 125 can separate the wet portion 115 from the dry portion 110. The fluid flow control valve 125 can control the flow of the fire suppressing fluid when the dry sprinkler system configuration 102 is activated such that the fire suppressing fluid can flow from the wet portion 115 to the dry portion 110 and discharge from the sprinkler 120. The time it takes for the fire suppressing fluid to reach the sprinkler can be determined by the data processing system 130.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The terms “approximately,” “about,” “substantially”, and similar terms are intended to include any given ranges or numbers +/−10%. These terms include insubstantial or inconsequential modifications or alterations of the subject matter described and claimed are considered to be within the scope of the disclosure as recited in the appended claims.

The term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A dry sprinkler simulation system, comprising:
a data processing system having:
a plurality of input components to receive a plurality of inputs, the plurality of input components including:
a fluid pressure determination component to receive a pressure value of a fire suppressing fluid;
an air pressure determination component to receive a pressure value of air;
a valve features determination component to receive characteristics of a fluid flow control valve; and
a trim determination component to receive a plurality of elements of a releasing trim;
a fluid delivery output component to estimate a discharge time of the fire suppressing fluid based on the plurality of inputs; and
a sprinkler system generator component to identify a dry sprinkler system configuration that includes a network of pipes, the fluid flow control valve, and at least one sprinkler coupled with a portion of the network of pipes.

2. The dry sprinkler simulation system of claim 1, comprising:
the network of pipes having a dry portion, a wet portion fluidly coupled with the dry portion, the fluid flow control valve separating the wet portion from the dry portion, and the at least one sprinkler to receive the fire suppressing fluid via the wet portion of the network of pipes.

3. The dry sprinkler simulation system of claim 1, comprising:
the data processing system to receive the plurality of inputs from an end user.

4. The dry sprinkler simulation system of claim 1, comprising:
the data processing system to receive the plurality of inputs from a database.

5. The dry sprinkler simulation system of claim 1, comprising:
the valve features determination component to receive a volume of a transmitting fluid of the releasing trim.

6. The dry sprinkler simulation system of claim 1, comprising:
the trim determination component to receive a pressure value at a location within the releasing trim and a volume of a pipe within the releasing trim.

7. A data processing system to determine a dry sprinkler system configuration, the data processing system comprising:
a plurality of input components to receive a plurality of inputs, the plurality of input components including:
a fluid pressure determination component to receive a pressure value of a fire suppressing fluid;
an air pressure determination component to receive a pressure value of air;
a valve features determination component to receive characteristics of a fluid flow control valve; and
a trim determination component to receive a plurality of elements of a releasing trim;
a fluid delivery output component to determine a discharge time of the fire suppressing fluid to a sprinkler of the dry sprinkler system configuration; and
a sprinkler system generator component to identify the dry sprinkler system configuration that includes a network of pipes, the fluid flow control valve, and at least one sprinkler coupled with a portion of the network of pipes.

8. The data processing system of claim 7, comprising:
the data processing system to receive the plurality of inputs from an end user.

9. The data processing system of claim 7, comprising:
the data processing system to receive the plurality of inputs from a database.

10. The data processing system of claim 7, comprising:
the trim determination component to receive a length value of a pipe of the releasing trim.

11. The data processing system of claim 7, comprising:
the trim determination component to receive a vertical displacement value defined between two points within the releasing trim.

12. The data processing system of claim 7, comprising:
the trim determination component to receive a pressure value at a location within the releasing trim.

13. The data processing system of claim 7, comprising:
the valve features determination component to receive a volume of a transmitting fluid of the releasing trim.

14. The data processing system of claim 7, comprising:
the valve features determination component to receive a stiffness value of a portion of the fluid flow control valve.

15. A method of determining a dry sprinkler system configuration, comprising:
receiving, via a data processing system, a plurality of inputs based on conditions at a plurality of locations of the dry sprinkler system configuration;
determining, via the data processing system, a discharge time of a fire suppressing fluid to at least one sprinkler based on the plurality of inputs;
the dry sprinkler system configuration including a network of pipes having a dry portion, a wet portion fluidly coupled with the dry portion, and a fluid flow control valve separating the wet portion from the dry portion; and
the at least one sprinkler fluidly coupled with the dry portion of the network of pipes, the at least one sprinkler to receive the fire suppressing fluid from the wet portion of the network of pipes.

16. The method of claim 15, comprising:
receiving, via an end user, the plurality of inputs.

17. The method of claim 15, comprising:
receiving, via a database, the plurality of inputs.

18. The method of claim 15, comprising:
receiving a supply pressure value of the fire suppressing fluid at a first plurality of locations of the dry sprinkler system configuration.

19. The method of claim 15, comprising:
receiving a pressure value of air at a location downstream of the fluid flow control valve.

20. The method of claim 15, comprising:
receiving a volume of a transmitting fluid within the fluid flow control valve.

21. The method of claim 15, comprising:
receiving a plurality of characteristics of a releasing trim of the fluid flow control valve.

22-30. (canceled)
